(19) United States
(12) Patent Application Publication
(10) Pub. No.: US 2024/0426868 A1
(43) Pub. Date: Dec. 26, 2024

(54) MEMS SENSOR FOR IMPROVED MEASUREMENT OF ACCELERATIONS

(71) Applicant: STMicroelectronics International N.V., Geneva (CH)

(72) Inventors: Francesco RIZZINI, Passirano (IT); Gabriele GATTERE, Castronno (IT)

(73) Assignee: STMicroelectronics International N.V., Geneva (CH)

(21) Appl. No.: 18/738,990

(22) Filed: Jun. 10, 2024

(30) Foreign Application Priority Data
Jun. 20, 2023 (IT) 102023000012669

(51) Int. Cl. G01P 15/125; G01P 21/00

(52) U.S. Cl. CPC G01P 15/125; G01P 21/00

(57) ABSTRACT

A MEMS sensor comprising a semiconductor body and a mass elastically coupled to the semiconductor body for oscillating with respect to the semiconductor body in a oscillation direction in response to a force acting on the mass in the oscillation direction, the force being caused by an acceleration applied to the MEMS sensor. The mass and the semiconductor body define at least one measurement structure with parallel-plate electrodes, which is configured to measure capacitively a position of the mass that is indicative of the acceleration applied to the MEMS sensor. The mass and the semiconductor body further define a calibration structure with comb-finger electrodes that is electrically controllable, in a calibration mode of the MEMS sensor, to bring about electrostatically a displacement of the mass with respect to the semiconductor body in the oscillation direction.

### BACKGROUND

### Technical Field

The present disclosure relates to a MEMS sensor for improved measurement of accelerations.

### Description of the Related Art

As is known, an accelerometer is a sensor that enables measurement of accelerations.

As illustrated by way of example in FIG. 1A, the accelerometer 1 generally comprises a substrate (or semiconductor body) 3 and a seismic mass (or, more simply, mass) 5 elastically coupled to the substrate 3 via springs (not shown in FIG. 1A).

Thanks to the deformation of the springs, the seismic mass 5 may displace with respect to the substrate 3 in response to an external force that acts on the seismic mass 5 and that corresponds to a respective acceleration applied to the sensor.

The displacement of the seismic mass 5 may be measured via various techniques, for example via capacitive detection based upon a measurement structure of the accelerometer 1 formed by sensing electrodes 7.

Generally, parallel-plate (PP) electrodes are used as sensing electrodes 7 because, as compared to the currently known solutions, they provide the maximum sensitivity of measurement of acceleration.

The PP electrodes 7 define one or more detection capacitors and comprise one or more detection rotors (fixed to the seismic mass 5) and one or more detection stators (fixed to the substrate 3), arranged so as to vary their relative distances in response to the movement of the seismic mass 5 with respect to the substrate 3.

For instance, FIG. 1A shows a rotor 7a and two stators 7b and 7c. The rotor 7a is arranged between the two stators 7b and 7c in the direction of oscillation of the seismic mass 5 (here parallel to the axis X) and is spaced apart from the stators 7b and 7c by respective relative distances D₁ and D₂. Each stator and rotor pair defines a respective detection capacitor.

In use, these variations of the relative distances D₁ and D₂ generate corresponding variations of capacitance of the detection capacitors, which are measured and are indicative of the movement of the seismic mass 5 and thus of the acceleration applied to the accelerometer 1.

In particular, FIG. 1B shows the plot of a differential variation of capacitance DCₒᵤₜ of the PP electrodes 7 as a function of the acceleration accᵢₙ applied to the accelerometer 1 of FIG. 1A. The differential variation of capacitance DCₒᵤₜ is dependent upon the difference of the respective capacitances C₁ and C₂ of the detection capacitors of the PP electrodes 7. For instance, DCₒᵤₜ=C₂-C₁.

Ideally and as illustrated schematically in FIG. 1A, the rotor 7a of the PP electrodes 7 is equidistant from the stators 7b, 7c of the PP electrodes 7 in the direction of oscillation of the seismic mass 5, in a resting condition of the accelerometer 1 where the accelerations are absent. In other words, D₁=D₂ in the resting condition of the accelerometer 1.

In this way, the plot of the differential variation of capacitance DCₒᵤₜ is ideally of a nonlinear type and symmetrical with respect to the origin of the axes (corresponding to the resting condition of the accelerometer 1, where: accᵢₙ=0 g). In particular, the fact that the curve DCₒᵤₜ(accᵢₙ) is symmetrical with respect to the origin of the axes implies that, at values of acceleration, provided by way of example, +accᵢₙ* and −accᵢₙ* that are mutually symmetrical with respect to the origin, the corresponding differential variations of capacitance are equal to one another in absolute value and are respectively equal to +A* and −A*.

When the plot of the differential variation of capacitance is symmetrical with respect to the origin of the axes, a vibration rectification error (VRE) is zero. In this case, the accuracy of measurement of the acceleration is optimal.

However, on account of problems of fabrication such as adhesion of the seismic mass 5 to the substrate 3 during its release from the latter in the course of manufacture of the accelerometer 1, it is possible that there may be present an offset in the position of the rotor 7a with respect to the stators 7b and 7c. In other words, it may happen that D₁≠D₂ in the resting condition of the accelerometer 1 (FIG. 2A). This phenomenon is also referred to as “zero-g offset” (ZGO) displacement.

The above structural asymmetry of the PP electrodes 7 means that the curve DCₒᵤₜ(accᵢₙ) is asymmetrical with respect to the origin of the axes in the resting condition of the accelerometer 1 and that consequently, at the values of acceleration provided by way of example +accᵢₙ* and −accᵢₙ*, the corresponding differential variations of capacitance are different from one another in absolute value and are respectively equal to +A₁* and −A₂* with |A₁*|≠|A₂*|.

When the ZGO displacement is present and thus the plot of the differential variation of capacitance is asymmetrical with respect to the origin of the axes, a nonzero VRE is present.

The ZGO displacement and the consequent nonzero VRE are generally compensated via some known solutions.

For instance, it is possible to use as sensing electrodes 7 comb-finger (CF) electrodes instead of the PP electrodes. The CF electrodes have a DCₒᵤₜ (accᵢₙ) that is linear and thus is less affected by the nonzero VRE. However, the CF electrodes have a worse signal-to-noise ratio (SNR) and thus entail a reduced accuracy of measurement of the acceleration.

It is also possible to compensate for the measurement of the accelerometers in a testing step subsequent to their production. This may be obtained by carrying out a characterization of the accelerometers and, on the basis of this characterization, by performing a subsequent compensation of the effects caused by the ZGO displacement (e.g., via a compensation of the curve DCₒᵤₜ(accᵢₙ) during post-processing or else via additional manufacturing steps aimed at zero-set of the ZGO displacement of each accelerometer). In particular, this characterization of the properties of the accelerometers may be done individually for each accelerometer or else collectively (e.g., per type of accelerometer and/or per production lot, thus carrying out a statistical characterization of a family of accelerometers). The first characterization type optimizes the accuracy of measurement of the accelerometers but is not a practical solution for mass production of the accelerometers, in so far as it is too costly both from an economic standpoint and from the standpoint of the times involved. The second characterization type may be implemented in mass production but remains subject to measurement errors due to the intrinsic structural deviations of the specific accelerometers as compared to the exemplars of accelerometers used for characterization.

### BRIEF SUMMARY

The present disclosure is to provide a MEMS sensor, a measurement device comprising the MEMS sensor, a method for controlling the MEMS sensor implemented by the measurement device, and a corresponding computer program product that will overcome the drawbacks of the prior art.

According to the present disclosure a MEMS sensor, a measurement device comprising the MEMS sensor, a method for controlling the MEMS sensor implemented by the measurement device, and a corresponding computer program product are provided, as defined in the annexed claims.

The present disclosure relates to a MEMS sensor for improved measurement of accelerations. In particular, it relates to a MEMS sensor (in detail an accelerometer) with a calibration structure that may be used in a calibration step of the MEMS sensor for calibration of the latter. In addition, it relates to a measurement device comprising the MEMS sensor, to a method for controlling the MEMS sensor implemented by the measurement device, and to a corresponding a computer program product.

### BRIEF DESCRIPTION OF THE SEVERAL VIEWS OF THE DRAWINGS

For a better understanding of the present disclosure a preferred embodiment is now described, purely by way of non-limiting example, with reference to the attached drawings, wherein:

FIG. 1A is a schematic top plan view of a known accelerometer that does not present ZGO displacement;

FIG. 1B is a graph showing an electrical signal measured via the known accelerometer of FIG. 1A;

FIG. 2A is a schematic top plan view of a known accelerometer that presents ZGO displacement;

FIG. 2B is a graph that shows an electrical signal measured via the known accelerometer of FIG. 2A;

FIG. 3 is a schematic top plan view of a MEMS sensor, according to one embodiment;

FIG. 4 is a block diagram that shows schematically a measurement device comprising the MEMS sensor of FIG. 3, according to one embodiment;

FIG. 5 is a block diagram that shows schematically a method for controlling the MEMS sensor of FIG. 3, according to one embodiment; and

FIGS. 6A-6C are graphs showing the plot of electrical signals obtained by carrying out the control method FIG. 5.

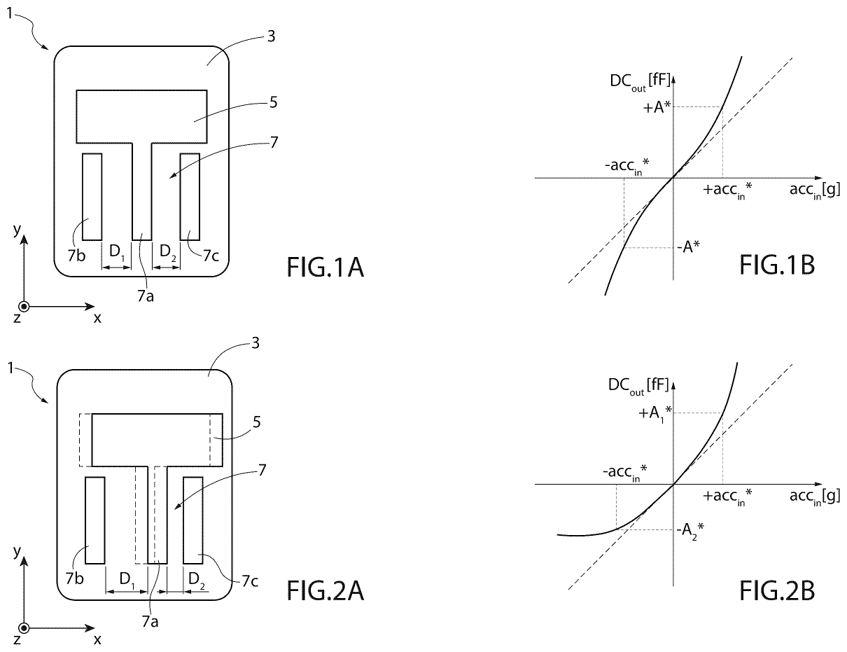

### DETAILED DESCRIPTION

In particular, in the figures a triaxial cartesian reference system is used defined by an axis X, an axis Y, and an axis Z, orthogonal to one another.

In the ensuing description, elements common to the different embodiments are designated by the same reference numbers.

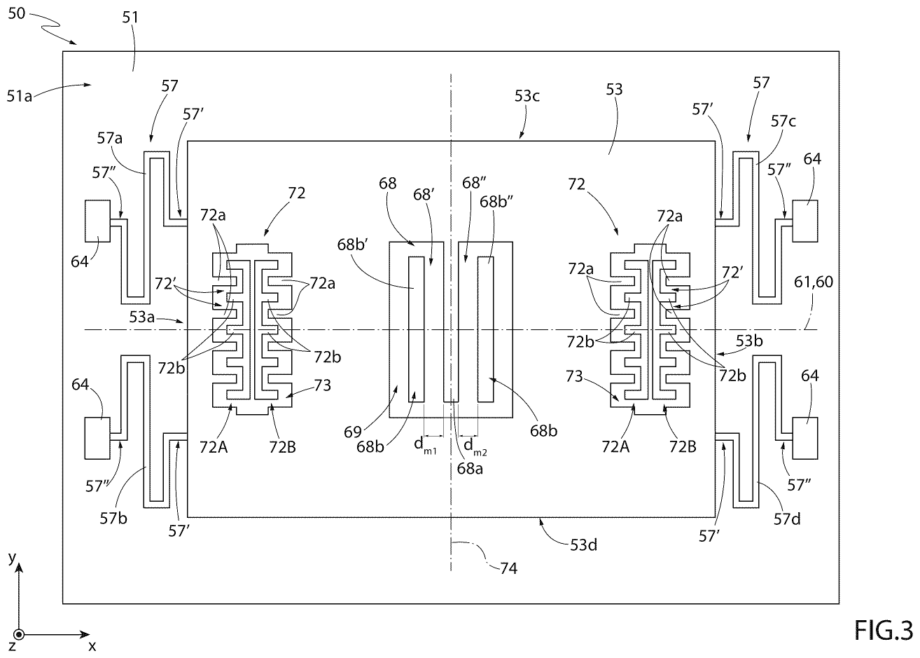

FIG. 3 shows a MEMS (MicroElectroMechanical Systems) sensor 50, in particular a MEMS accelerometer, configured to detect accelerations and hereinafter also referred to as “sensor 50”.

FIG. 3 is a top plan view (i.e., in a plane XY defined by the axes X and Y) of the sensor 50.

In FIG. 3 only the elements useful for an understanding of the present embodiment are illustrated, whereas elements or components that, albeit present in the finished sensor, are not important for the present disclosure are not illustrated.

The sensor 50 is described herein by way of example as an accelerometer of a uniaxial type (in particular, configured to detect accelerations along the axis X). However, it is evident that the present description applies in a similar way also to the case of biaxial or triaxial accelerometers.

The sensor 50, obtained using MEMS technology (i.e., with methods for machining semiconductors) comprises a semiconductor body 51 of semiconductor material such as silicon (Si), having a surface 51a that extends in a direction parallel to the plane XY (i.e., the axis Z is substantially orthogonal to the surface 51a).

The sensor 50 further comprises a seismic mass (or mobile structure or, more simply, mass) 53 having a mass M.

The seismic mass 53 is made, for example, of semiconductor material (such as silicon or polysilicon) and extends in a direction parallel to the surface 51a of the semiconductor body 51, at a different height, along the axis Z, with respect to the surface 51a. In other words, the seismic mass 53 faces the surface 51a of the semiconductor body 51 and is at a distance from the latter.

The seismic mass 53 is elastically coupled to the semiconductor body 51, in particular via an elastic assembly 57, so as to oscillate in use relative to the semiconductor body 51 in an oscillation direction 61 that in FIG. 3 is by way of example parallel to the axis X.

In detail, the elastic assembly 57 has a constant of elasticity K.

Consequently, the elastic assembly 57 is deformable (i.e., it may be lengthened/shortened) in a direction of deformation 60 that is parallel to the axis X and, for example, coincides with the oscillation direction 61 of the seismic mass 53.

For instance, the elastic assembly 57 is made of semiconductor material, such as silicon or polysilicon.

In the embodiment illustrated by way of example in FIG. 3, the elastic assembly 57 comprises a first spring 57a, a second spring 57b, a third spring 57c, and a fourth spring 57d, arranged in pairs on sides 53a and 53b of the seismic mass 53 that are opposite to one another in the oscillation direction 61. However, the number of springs of the elastic assembly 57 and their arrangement may vary in a per se obvious manner (for example, there may be two or more than four springs), provided that this allows movement of the seismic mass 53 in the oscillation direction 61, relative to the semiconductor body 51.

In particular, each spring 57a-57d of the elastic assembly 57 has a respective first end 57′ and a respective second end 57″ opposite to one another along the axis X. The first ends 57′ of the springs 57a-57d are fixed to the seismic mass 53 (in particular, to the respective sides 53a and 53b of the seismic mass 53), and the second ends 57″ of the springs 57a-57d are fixed to the semiconductor body 51. For instance, the second ends 57″ of the springs 57a-57d are fixed to respective fixing elements 64 that extend over the surface 51a of the semiconductor body 51 and are in turn fixed to the semiconductor body 51 so as to render fixed with respect to one another the semiconductor body 51 and the second ends 57″ of the springs 57a-57d.

In the embodiment illustrated by way of example in FIG. 3, the springs 57a-57d are folded springs, for example serpentine springs. In particular, such serpentine springs are of a planar type and obtained using MEMS technology (i.e., by methods of machining of semiconductors). More in detail, the above serpentine springs may include first portions, which extend parallel to one another and to the axis Y, and second portions, which extend parallel to one another and to the axis X. The first and the second portions are connected together and mutually arranged so as to form a serpentine path: each first portion is connected, at its ends (opposite to one another along the axis Y), to respective second portions, and each second portion is connected, at its ends (opposite to one another along the axis X), to respective first portions, except for two second portions that form the ends 57′ and 57″ (each of these latter second portions being arranged at a respective end of said path along the axis X and being joined to just one respective first portion).

Furthermore, the sensor 50 comprises one or more measurement structures 68 configured to measure the accelerations in the oscillation direction 61 to which the seismic mass 53 is subjected. In detail, the measurement structures 68 are configured to capacitively detect displacements in the oscillation direction 61 of the seismic mass 53, relative to the semiconductor body 51; said displacements are the result of external forces that act on the sensor 50 and that are due to accelerations applied to the sensor 50.

In the embodiment provided by way of example in FIG. 3, just one measurement structure 68 is considered. However, the number of measurement structures 68 may be greater in other embodiments.

The measurement structure 68 is implemented via parallel-plate (PP) electrodes so as to maximize the sensitivity of measurement of accelerations.

In particular, the seismic mass 53 includes one or more mobile measurement electrodes 68a (measurement rotors) of the measurement structure 68, fixed to the seismic mass 53. For instance, the one or more mobile measurement electrodes 68a are formed by respective projections of the seismic mass 53 (for example, having a substantially rectangular shape in the plane XY).

FIG. 3 shows by way of example the case where one mobile measurement electrode 68a is present, even though the number of the mobile measurement electrodes 68a may be greater in other embodiments of the sensor 50.

In addition, the semiconductor body 51 comprises one or more fixed measurement electrodes 68b (measurement stators) of the measurement structure 68 that are fixed with respect to the semiconductor body 51 and extend over the surface 51a.

FIG. 3 shows by way of example the case where two fixed measurement electrodes 68b′ and 68b″ are present, even though the number of fixed measurement electrodes 68b may be different in further embodiments of the sensor 50.

In FIG. 3, the fixed measurement electrodes 68b′, 68b″ are physically and electrically separated from one another (in detail, they are connected to respective pads that may be biased, as described more fully in what follows) so that the mobile measurement electrode 68a is arranged between the fixed measurement electrodes 68b′ and 68b″ in the oscillation direction 61, thus forming the PP structure.

In particular, each fixed measurement electrode 68b′ and 68b″ forms, with the mobile measurement electrode 68a, a respective measurement capacitor 68′, 68″. The measurement capacitors 68′ and 68″ are variable capacitors, the capacitance of which depends upon the respective distance dₘ₁, dₘ₂ between the mobile measurement electrode 68a and the respective fixed measurement electrode 68b′, 68b″.

In the embodiment provided by way of example in FIG. 3, the seismic mass 53 may include a measurement through opening (alternatively, a cavity) 69, in which the measurement electrodes 68a and 68b extend.

In detail, the seismic mass 53 encloses and delimits the measurement through opening 69, which traverses the seismic mass 53 in a direction transverse to the surface 51a of the semiconductor body 51. The fixed measurement electrodes 68b extend in the measurement through opening 69 and the mobile measurement electrode 68a projects into the measurement through opening 69 and extends between the fixed measurement electrodes 68b.

However, other arrangements may likewise be considered, in a per se obvious manner. For instance, the fixed measurement electrodes 68b may face one of the sides 53c, 53d of the seismic mass 53 that are transverse to the sides 53a and 53b (e.g., that are orthogonal to the latter and extend substantially in a direction parallel to the axis X), and the mobile measurement electrode 68a may extend from the respective side 53c, 53d.

Furthermore, the sensor 50 comprises one or more calibration structures 72 configured to implement electrostatically the seismic mass 53 in a calibration step of the sensor 50 so as to cause the seismic mass 53 to oscillate in the oscillation direction 61 and thus for simulating application of accelerations to the sensor 50. In detail, the one or more calibration structures 72 are configured to generate, via the capacitive effect, displacements of the seismic mass 53 in the oscillation direction 61; said displacements simulate external forces that act on the sensor 50 and that would be due to accelerations applied to the sensor 50.

In the embodiment provided by way of example in FIG. 3, two calibration structures 72 are considered. However, the number of the calibration structures 72 may be different in other embodiments (e.g., there may be one, or more than two).

Each calibration structure 72 is implemented via comb-finger (CF) electrodes.

In particular, the seismic mass 53 includes a plurality of mobile calibration electrodes 72a (calibration rotors) of the calibration structure 72, which are fixed to the seismic mass 53, are arranged at a distance apart from one another in a direction orthogonal to the oscillation direction 61 (in particular along the axis Y), and each have, in the plane XY, a main extension parallel to the oscillation direction 61. For instance, the mobile calibration electrodes 72a are formed by respective projections of the seismic mass 53, for example having a substantially rectangular shape on the plane XY.

In addition, the semiconductor body 51 comprises a plurality of fixed calibration electrodes 72b (calibration stators) of the calibration structure 72, which are fixed with respect to the semiconductor body 51, extend over the surface 51a, and, in the plane XY, each have a main extension parallel to the oscillation direction 61. The fixed calibration electrodes 72b are arranged at a distance apart from one another in a direction orthogonal to the oscillation direction 61, in particular along the axis Y.

The number of the mobile calibration electrodes 72a and of the fixed calibration electrodes 72b may vary as a function of the compromise between a small area of occupation of the calibration structure 72 and a strong electrostatic coupling generated by the calibration structure 72, which makes it possible to obtain a high electrostatic force of actuation.

The mobile calibration electrodes 72a and the fixed calibration electrodes 72b of each calibration structure 72 are comb-finger so as to form, in a direction parallel to the axis Y, one or more arrays of calibration electrodes that each have an alternating succession of mobile calibration electrodes 72a and fixed calibration electrodes 72b. In other words, along the axis Y each mobile calibration electrode 72a extends at least partially between two respective fixed calibration electrodes 72b, and each fixed calibration electrode 72b extends at least partially between two mobile calibration electrodes 72a (except for the end electrodes of the arrays).

In the embodiment provided by way of example in FIG. 3, each calibration structure 72 comprises two sets of mobile calibration electrodes 72a and two sets of fixed calibration electrodes 72b arranged so as to form two arrays 72A and 72B, arranged side by side in the oscillation direction 61, of comb-finger electrodes. For instance, the two sets of fixed calibration electrodes 72b are arranged, in the oscillation direction 61, internally with respect to the mobile calibration electrodes 72a and so as to face each the respective set of mobile calibration electrodes 72a with which they are comb-finger. However, the number of sets of mobile calibration electrodes 72a and fixed calibration electrodes 72b (and, consequently, the number of arrays of comb-finger electrodes) may vary in a per se obvious manner and be, for example, less or greater than what is shown in FIG. 3.

For instance, the fixed calibration electrodes 72b of each array 72A, 72B are electrically connected together via a respective connection region that extends in a direction parallel to the axis Y, in electrical contact with (or else a continuation of) ends of the fixed calibration electrodes 72b that are opposite, in a direction parallel to the oscillation direction 61, to the mobile calibration electrodes 72a. The fixed calibration electrodes 72b of the arrays 72A and 72B are, instead, electrically uncoupled from one another; i.e., they are not joined to one another by electrically conductive elements common to both of the arrays 72A and 72B.

Since the seismic mass 53 may oscillate in the oscillation direction 61 with respect to the semiconductor body 51 and since the calibration electrodes each have a main extension parallel to the oscillation direction 61 and are comb-finger and in alternating succession in a direction orthogonal to the oscillation direction 61 (in detail, in a direction parallel to the axis Y), the mobile calibration electrodes 72a may move relative to the fixed calibration electrodes 72b and thus increase/decrease the respective facing areas (i.e., overlapping areas) between the mobile calibration electrodes 72a and the fixed calibration electrodes 72b facing one another.

Each pair made up of a mobile calibration electrode 72a and a fixed calibration electrode 72b, that are consecutive and face one another in the respective array of electrodes, forms a respective variable-capacitance calibration capacitor 72′. In particular, the capacitance of each calibration capacitor 72′ is proportional to the facing area between the mobile calibration electrode 72a and the fixed calibration electrode 72b, which depends upon the mutual position of the seismic mass 53 and of the semiconductor body 51 in the oscillation direction 61.

In the embodiment provided by way of example in FIG. 3, the seismic mass 53 may include one respective calibration through opening (alternatively, one calibration cavity) 73 for each calibration structure 72, in which the respective calibration electrodes 72a and 72b extend.

In detail, the seismic mass 53 encloses and delimits the calibration through openings 73 that traverse the seismic mass 53 in a direction transverse to the surface 51a of the semiconductor body 51. The fixed calibration electrodes 72b extend in the respective calibration through openings 73, and the mobile calibration electrodes 72a project into the respective calibration through openings 73 so as to be comb-finger with the respective fixed calibration electrodes 72b.

However, other arrangements may likewise be considered, in a per se obvious manner. For instance, for each calibration structure 72 the fixed calibration electrodes 72b may face one of the sides 53a and 53b of the seismic mass 53, and the mobile calibration electrodes 72a may extend from the respective side 53a, 53b of the seismic mass 53 so as to be comb-finger with the respective fixed calibration electrodes 72b.

Furthermore, the sensor 50 may comprise blocking elements (not illustrated), which are fixed with respect to the semiconductor body 51, extend over the surface 51a of the semiconductor body 51, and face, and are at a distance from, the sides 53a and 53b of the seismic mass 53. The blocking elements are arranged, relative to the seismic mass 53, so as to bear upon the latter when the sensor 50 is subjected to accelerations higher than a threshold acceleration. In this way, it is possible to prevent said excessively high accelerations from causing oscillations of the seismic mass in the oscillation direction 61 so wide as to damage the elastic assembly 57 and in general the sensor 50. In particular, the minimum distances of the blocking elements from the seismic mass 53 are less than the distances dₘ₁, dₘ₂ of the measurement structure 68 and the maximum relative sliding of the calibration electrodes of the calibration structure 72 so as to prevent any direct physical contact between these electrodes and in general damage to the measurement structure 68 and the calibration structure 72.

In the embodiment provided by way of example in FIG. 3, in a resting condition of the sensor 50 in which the seismic mass 53 is not subject to accelerations in the oscillation direction 61, the sensor 50 has axial symmetry with respect to a middle axis 74 that is orthogonal to the oscillation direction 61 and parallel to the surface 51a (in particular, parallel to the axis Y) and for example passes through a center (e.g., the centroid, not shown) of the seismic mass 53.

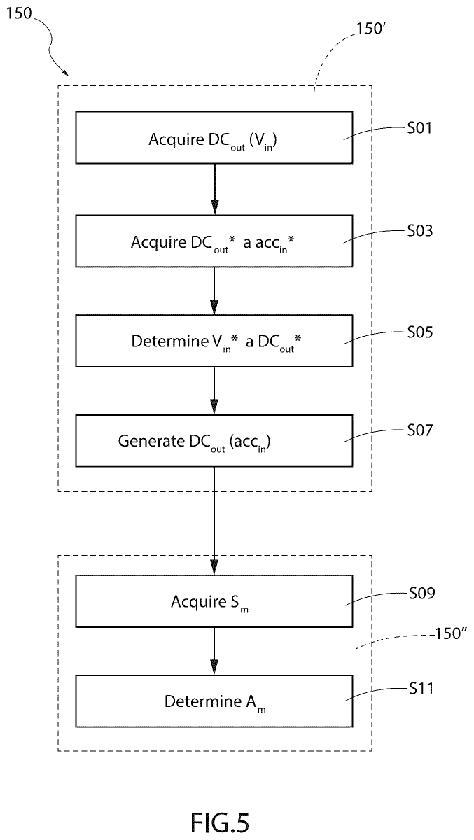

The sensor 50 may be operated in a mode of normal use (or mode of measurement of accelerations) or else in a calibration mode. The calibration mode precedes the measurement mode and makes it possible to calibrate the sensor 50, as described more fully with reference to FIG. 5. For instance, the sensor 50 is operated in the calibration mode once, after its production and before being used by the end user; alternatively, the sensor 50 may be operated in the calibration mode several times and, for example, periodically (e.g., once after its production and before being used by the end user, and the subsequent times whenever a period of time of use has elapsed and/or whenever the end user so wishes).

In the measurement mode of the sensor 50 and thus during normal use of the sensor 50, the seismic mass 53 oscillates in the oscillation direction 61 with respect to the semiconductor body 51 in response to the accelerations perceived by the sensor 50, and the measurement structure 68 capacitively detects the displacements of the seismic mass 53 in the oscillation direction 61 in order to measure the accelerations.

In detail, the seismic mass 53 (and thus the mobile measurement electrode 68a that is part thereof) is biased in a per se known manner with a biasing signal (in particular, a first biasing voltage V1, for example with square waveform). The first biasing voltage V1 oscillates, around an effective value of biasing voltage, at a biasing frequency (or rotor frequency) fᵣₒₜ higher than a mechanical resonance frequency fᵣₑₛ of the sensor 50. In greater detail, the biasing frequency fᵣₒₜ is higher by at least one order of magnitude than the mechanical resonance frequency fᵣₑₛ (e.g., fᵣₒₜ˜10-300 kHz and fᵣₑₛ˜1-10 kHz) so that the mechanical properties of the seismic mass 53 (e.g., its motion) will not be affected by the first biasing voltage V1. For instance, the first biasing voltage V1 is supplied from outside (e.g., by a biasing apparatus of a known type, or by an interface unit 104 described more fully in what follows) to pads of the sensor 50, not shown and present on the surface 51a of the semiconductor body 51, and is carried from these pads to the seismic mass 53 through one or more conductive paths defined, for example, by conductive paths electrically connected to the seismic mass 53 through the blocking elements and the elastic assembly 57.

In addition to biasing of the mobile measurement electrode 68a at the first biasing voltage V1, the fixed measurement electrodes 68b′ and 68b″ are biased at respective second biasing voltages V2′ and V2″, in particular of a DC type. Generally, the second biasing voltages V2′ and V2″ coincide with one another (V2′=V2″=V2) and are equal to the effective value of the first biasing voltage V1; this is the case considered by way of example in what follows. However, it is also possible to have V2′≠V2″ (in detail, by supplying to the respective pads electrically connected to the fixed measurement electrodes 68b′ and 68b″ the respective second biasing voltages V2′ and V2″ different from one another).

When the sensor 50 is subjected to an acceleration in the oscillation direction 61 (the condition of oscillation of the sensor 50, alternative to the resting condition), this acceleration generates an external force that acts on the seismic mass 53 and makes it oscillate in the oscillation direction 61 with respect to a resting position of the seismic mass 53 and in general with respect to the semiconductor body 51. Consequently, the springs 57a-57d of the elastic assembly 57 contract and lengthen in an alternating way with respect to one another on account of the respective forces of contraction and lengthening exerted thereon by the seismic mass 53.

Consequently, the distances dₘ₁, dₘ₂ of the measurement capacitors 68′ and 68″ (and thus the respective capacitances) vary as a function of the external force applied to the sensor 50.

It is thus possible to correlate in a known way, with said external force applied, the respective variations of capacitances of the measurement capacitors 68′, 68″ (acquired thanks to the biasing described previously of the seismic mass 53). In other words, it is possible to associate these measurements of variations of capacitances of the measurement capacitors 68′, 68″ to respective acceleration values so as to obtain the measurement of the accelerations.

In particular, and considering the ideal case where no ZGO displacement is present, a difference between the respective capacitances of the measurement capacitors 68′, 68″ (which is also referred to in what follows as “differential variation of capacitance DCₒᵤₜ” of the measurement structure 68) is zero in the resting condition of the sensor 50, but for, possibly, measurement noise not considered here in so far as it is not important for the purposes of the present description. Instead, the differential variation of capacitance DCₒᵤₜ of the measurement structure 68 is not zero in the condition of oscillation of the sensor 50.

As described more fully in what follows, the measurements of capacitance may be made via techniques in themselves known, for example via transimpedance amplifiers.

In the measurement mode of the sensor 50, the calibration structures 72 are not used. For instance, in this case the fixed calibration electrodes 72b are biased like the seismic mass 53, and thus also these are biased at the first biasing voltage V1.

In the calibration mode of the sensor 50 prior to its normal use, the measurement structure 68 is biased and used as described previously, and the calibration structures 72 are further used.

In particular, in the calibration mode, the seismic mass 53 (and thus the mobile calibration electrodes 72a that are part thereof) is biased at the first biasing voltage V1.

In addition, the fixed calibration electrodes 72b are biased at one or more calibration voltages.

In the embodiment of FIG. 3, where each calibration structure 72 comprises two respective comb-finger arrays 72A and 72B of electrodes, the fixed calibration electrodes 72b of the first array 72A are biased at a first calibration voltage V3′, and the fixed calibration electrodes 72b of the second array 72B are biased at a second calibration voltage V3″.

The calibration voltages V3′ and V3″ are, for example, of a DC type. In particular, the calibration voltages V3′ and V3″ are generally different from one another and present a relative difference ΔV=V3′−V3″. For instance, the calibration voltages V3′ and V3″ are comprised between approximately 0 V and approximately 20 V.

The calibration voltages V3′ and V3″ generate in each array 72A and 72B a respective force of electrostatic attraction between the mobile and fixed electrodes that has an intensity that differs between the two arrays 72A and 72B.

For instance, the calibration voltages V3′ and V3″ depend upon a common-mode voltage (of a per se known value, depending in a known way upon design factors and, purely by way of example, approximately 10 V) and by an additional voltage contribution (that depends upon the relative difference ΔV and in detail is equal to one half of the latter), which is respectively added and subtracted, periodically in time and in an alternating way for the calibration voltages V3′ and V3″, to/from the common-mode voltage to obtain the calibration voltages V3′ and V3″ so as to get the seismic mass to oscillate accordingly in the oscillation direction 61. For instance, considering a value of 10 V of the common-mode voltage and a value of 8 V of the relative difference ΔV, the calibration voltages V3′ and V3″ may assume values of 6 V and 14 V.

This causes, electrostatically, a progressive displacement of the seismic mass 53 in the oscillation direction 61. In particular, and with reference to FIG. 3, the seismic mass 53 shifts to the left when the right-hand array 72B has a force of electrostatic attraction higher than the left-hand array 72A (i.e., when the first calibration voltage V3′ is higher than the second calibration voltage V3″), and shifts to the right when the left-hand array 72A has a force of electrostatic attraction higher than the right-hand array 72B (i.e., when the second calibration voltage V3″ is higher than the first calibration voltage V3′).

For instance, the calibration voltages V3′ and V3″ are supplied from outside (e.g., by a biasing apparatus of a known type or by the interface unit 104 described more fully in what follows) to respective pads of the sensor 50, not illustrated and present on the surface 51a of the semiconductor body 51, and are carried by these pads to the fixed calibration electrodes 72b of the respective arrays 72A, 72B through one or more conductive paths defined, for example, by conductive leads.

Consequently, via the calibration voltages V3′ and V3″ it is possible, starting from the resting position of the seismic mass 53, to displace the seismic mass 53 between two end calibration positions of its path in the oscillation direction 61.

These two end calibration positions are opposite to one another in the oscillation direction 61 with respect to the resting position of the seismic mass 53 and may coincide with the positions of the seismic mass 53 when the latter bears upon the blocking elements, or else may be comprised between the positions that the seismic mass 53 assumes when it bears upon the blocking elements. In general, the path of the seismic mass 53 comprised between the two end calibration positions corresponds to the path that the seismic mass 53 generally performs during its normal use.

In particular, in the calibration mode, the calibration structures 72 are controlled electrically so as to displace the seismic mass 53 between the end calibration positions, i.e., along a range of displacement of the seismic mass 53. This substantially simulates application to the sensor 50 of accelerations comprised in a range of calibration accelerations defined between two end calibration accelerations (corresponding to the end calibration positions).

Simultaneously with electrostatic actuation of the seismic mass 53 by the calibration structures 72, the measurement structure 68 measures the displacements of the seismic mass 53 generated by the calibration structures 72. In other words, the measurement structure 68 generates at output electrical signals (described more fully in what follows and designated hereinafter by the references Sᵣ₁ and Sᵣ₂) that are indicative of the accelerations electrostatically induced by the calibration structures 72.

The acceleration values measured in the calibration mode are then used for calibrating the sensor 50, as described more fully hereinafter with reference to FIG. 5.

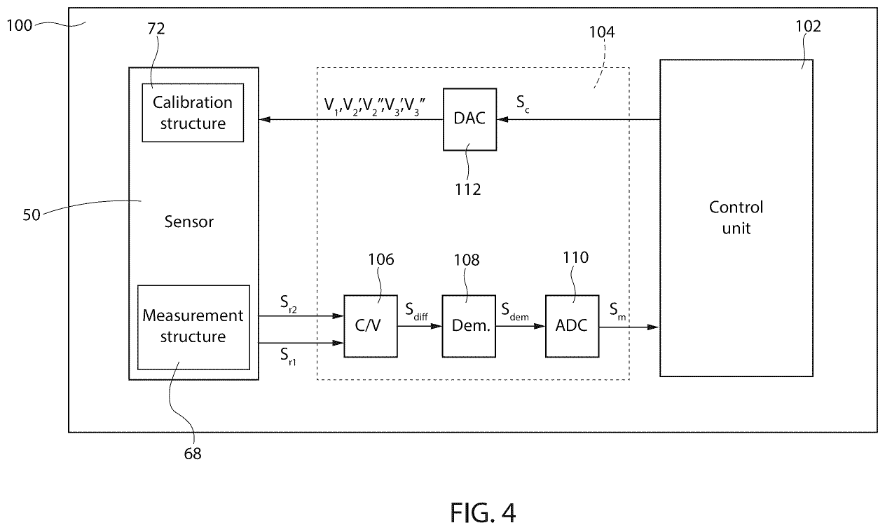

As illustrated in FIG. 4, the sensor 50 is comprised in a measurement device 100 configured to measure accelerations acting in the oscillation direction 61 (here parallel to the axis X).

In detail, the measurement device 100 implements in use a control method (discussed more fully in what follows with reference to FIG. 5 and designated by the reference 150) that makes it possible to control the sensor 50 in order to measure these accelerations in an optimized way.

In detail, the measurement device 100 comprises a control unit 102 electrically coupled to the sensor 50 for controlling the latter and for detecting the accelerations in the oscillation direction 61 to which it is subjected. The control unit 102 is also configured, in the calibration mode, for controlling the calibration structures 72 and thus electrostatically actuating the seismic mass 53.

In greater detail, the control unit 102 receives a measurement signal Sₘ indicative of the acceleration detected by the sensor 50 and generates control signals S_{c} for control of the sensor 50.

The measurement device 100 may further comprise an interface unit 104 electrically coupled to the sensor 50 and to the control unit 102 to interface them with one another.

In particular, the interface unit 104 comprises a capacitance-to-voltage (C/V) conversion block 106, a demodulation block 108, an analog-to-digital conversion (ADC) block 110 and a digital-to-analog conversion (DAC) block 112.

The C/V conversion block 106 (e.g., implemented by a transimpedance amplifier) is electrically coupled to the measurement structure 68 and in use receives a first detection signal Sᵣ₁ and a second detection signal Sᵣ₂ from the measurement structure 68 of the sensor 50. The first and second detection signals Sᵣ₁, Sᵣ₂ are electrical signals (e.g., current signals) indicative of the capacitance of the first measurement capacitor 68′ and the second measurement capacitor 68″, respectively. The C/V conversion block 106 generates, on the basis of the difference between the first detection signal Sᵣ₁ and the second detection signal Sᵣ₂, a differential signal (or differential voltage) S_{diff}(e.g., voltage signal) indicative of the acceleration detected by the sensor 50.

The demodulation block 108 receives the differential signal S_{diff} from the C/V conversion block 106 and generates a demodulated signal (or demodulated voltage) S_{dem} via demodulation of the differential signal S_{diff}, in a per se known manner. In detail, the demodulated signal S_{dem} is without the component of the differential signal S_{diff} at the biasing frequency fᵣₒₜ and thus is indicative only of the detected acceleration and not also of the driving modulation applied to the sensor 50.

The ADC block 110 receives the demodulated signal S_{dem} and converts it from an analog signal to a digital signal in a per se known manner, thus generating at output the measurement signal Sₘ that is received by the control unit 102.

The control unit 102 receives at input the measurement signal Sₘ indicative of the acceleration measured and generates at output the control signals S_{c} configured to control operation of the sensor 50. The control unit 102 functions according to the control method 150 described more fully in what follows.

In detail, the control signals S_{c} are the digital signals corresponding to the analog signals to be applied to the sensor 50 (such as the first biasing voltage V1, the second biasing voltages V2′ and V2″, and, in the calibration mode, also the calibration voltages V3′ and V3″).

The DAC block 112 receives the control signals S_{c} and converts them from digital to analog in a per se known manner, generating at output the first biasing voltage V1 for the seismic mass 53, the second biasing voltages V2′ and V2″ for the fixed measurement electrodes 68b, and, in the calibration mode, also the calibration voltages V3′ and V3″ for the fixed calibration electrodes 72b of the arrays 72A and 72B. Alternatively, the first biasing voltage V1, the second biasing voltages V2′ and V2″, and, in the calibration mode, also the calibration voltages V3′ and V3″ may be generated outside the measurement device 100 and supplied to the latter, for example by a calibration machine (e.g., of an ATE type) external to the measurement device 100 and operatively coupled to the latter.

FIG. 5 shows the control method 150 for controlling the sensor 50.

The control method is executed by the control unit 102 and via the sensor 50.

The control method comprises a calibration step 150′, in which the sensor 50 is in the calibration mode, and a measurement step 150″, in which the sensor 50 is in the measurement mode (i.e., the mode of normal use). The calibration step 150′ is carried out before the measurement step 150″, as described more fully previously.

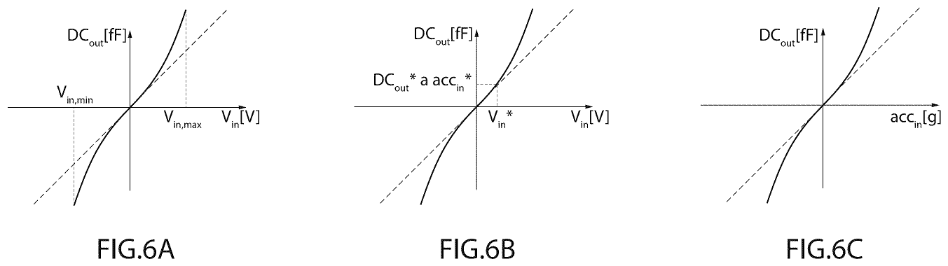

The calibration step 150′ comprises, in a step S01, acquisition by the control unit 102 of a curve DCₒᵤₜ(Vᵢₙ) (represented in FIG. 6A and also referred to as first curve), i.e., of the plot of the differential variation of capacitance DCₒᵤₜ as a function of the calibration input voltage Vᵢₙ supplied to the calibration structures 72.

The differential variation of capacitance DCₒᵤₜ depends upon the difference between the respective capacitances C₁ and C₂ of the detection capacitors 68′ and 68″. For instance, DCₒᵤₜ=C₂-C₁.

The calibration input voltage Vᵢₙ is the difference of electrostatic potential present between the fixed calibration electrodes 72b and the mobile calibration electrodes 72a of each calibration structure 72. Consequently, the calibration input voltage Vᵢₙ is a function of the first biasing voltage V1 and of the calibration voltages V3′ and V3″.

In the example considered, DCₒᵤₜ=C₂-C₁ and Vᵢₙ=ΔV. Consequently, DCₒᵤₜ=0 fF when Vᵢₙ=0 V and thus V3″=V3′, DCₒᵤₜ>0 fF when Vᵢₙ>0 V and thus V3′>V3″ (i.e., when, in each biasing structure 72, the right-hand array 72B has a force of electrostatic attraction higher than the left-hand array 72A), and DCₒᵤₜ<0 fF when Vᵢₙ<0 V and thus V3′<V3″ (i.e., when, in each biasing structure 72, the left-hand array 72A has a force of electrostatic attraction higher than the right-hand array 72B).

In particular, in step S01 the sensor 50 is controlled so as to apply to the biasing structures 72 the calibration input voltage Vᵢₙ variable in an input-voltage range. The input-voltage range is defined between a minimum value of calibration input voltage V_{in,min} and a maximum value of calibration input voltage V_{in,max}, which correspond to the end calibration positions of the seismic mass 53. For instance, the calibration input voltage Vᵢₙ is made to vary in a progressive way by varying the calibration voltages V3′ and V3″.

For each value of the calibration input voltage Vᵢₙ in the input-voltage range, the control unit 102 acquires a corresponding value of the measurement signal Sₘ. In the calibration mode of the sensor 50, the measurement signal Sₘ corresponds to the differential variation of capacitance DCₒᵤₜ to be used for calibration of the sensor 50.

The control unit 102 stores the measured values of the differential variation of capacitance DCₒᵤₜ throughout the input-voltage range so as to generate the curve DCₒᵤₜ(Vᵢₙ) illustrated in FIG. 6A.

In particular, the curve DCₒᵤₜ(Vᵢₙ) is of a nonlinear type (e.g., with a substantially cubic plot) and symmetrical with respect to the origin of the axes (i.e., to Vᵢₙ=0 V).

The calibration step 150′ further comprises, in a step S03 consecutive to step S01, acquisition by the control unit 102 of a reference differential variation of capacitance DCₒᵤₜ* at a reference acceleration accᵢₙ*.

In particular, this is obtained without the use of the calibration structures 72, which are deactivated and not biased.

Instead, this reference acceleration accᵢₙ* is supplied mechanically to the sensor 50. For instance, the sensor 50 is coupled to a movement apparatus (external to the measurement device 100 and of a per se known type, such as a shaker for MEMS accelerometers) that moves the sensor 50 so as to subject it to an acceleration equal to the reference acceleration accᵢₙ*.

While the sensor 50 is subjected to the reference acceleration accᵢₙ*, the control unit 102 acquires and stores the corresponding value of the differential variation of capacitance DCₒᵤₜ, i.e., the reference differential variation of capacitance DCₒᵤₜ*.

By way of non-limiting example, the reference acceleration accᵢₙ* is equal to 1 g. However, other acceleration values may be used, provided that they belong to the range of calibration accelerations.

The calibration step 150′ further comprises, in a step S05 consecutive to step S03, determination of a reference calibration input voltage Vᵢₙ* corresponding to the reference differential variation of capacitance DCₒᵤₜ* (FIG. 6B).

In particular, on the basis of the curve DCₒᵤₜ(Vᵢₙ) and of the reference differential variation of capacitance DCₒᵤₜ* measured at the reference acceleration accᵢₙ*, the value (Vᵢₙ*) of the calibration input voltage Vᵢₙ that in the curve DCₒᵤₜ(Vᵢₙ) corresponds to the differential variation of capacitance DCₒᵤₜ* is determined.

In this way a correlation between the scale of the acceleration values accᵢₙ and the scale of the calibration input voltages Vᵢₙ is generated.

The calibration step 150′ further comprises, in a step S07 consecutive to step S05, generation by the control unit 102 of a curve (also referred to as second curve) DCₒᵤₜ (accᵢₙ) (illustrated in FIG. 6C), i.e., of the plot of the differential variation of capacitance DCₒᵤₜ as a function of the input acceleration accᵢₙ.

This is obtained starting from the curve DCₒᵤₜ(Vᵢₙ) and as a function of the correspondence between the reference calibration input voltage Vᵢₙ* and the reference acceleration accᵢₙ*. In particular, in the curve DCₒᵤₜ (accᵢₙ) the scale of the abscissae of the curve DCₒᵤₜ(Vᵢₙ) (which corresponds to the calibration input voltage Vᵢₙ) is replaced with a scale of the abscissae that corresponds to the input acceleration accᵢₙ, on the basis of a point comparison between the calibration input voltages Vᵢₙ and the input accelerations accᵢₙ that is performed thanks to the correspondence between the reference calibration input voltage Vᵢₙ* and the reference acceleration accᵢₙ*.

Generation of the curve DCₒᵤₜ (accᵢₙ) terminates the calibration step 150′ and is such that the sensor 50 will be calibrated and the measurement device 100 will be able to measure in an accurate way the accelerations applied to the sensor 50.

The measurement step 150″ comprises, in a step S09 consecutive to step S07, acquisition by the control unit 102 of the measurement signal Sₘ at a given instant, corresponding to a respective acceleration value to be measured (in what follows designated by the reference Aₘ).

Consequently, in step S09 a value of differential variation of capacitance DCₒᵤₜ is acquired, which is indicative of the acceleration Aₘ that is to be measured and that is applied to the sensor 50 at the instant considered.

The measurement step 150″ further comprises, in a step S11 consecutive to step S09, determination by the control unit 102 of the acceleration value Aₘ as a function of the value of the measurement signal Sₘ acquired and of the curve DCₒᵤₜ(accᵢₙ).

In particular, this is obtained considering as acceleration value Aₘ the value of the input acceleration accᵢₙ that corresponds in the curve DCₒᵤₜ(accᵢₙ) to the measured value of differential variation of capacitance DCₒᵤₜ (i.e., to the value of the measurement signal Sₘ).

In this way, it is possible to obtain a measurement of the acceleration applied to the sensor 50 that is not affected by VRE due to the possible ZGO displacement of the sensor 50.

The control method 150 may be implemented via a corresponding computer program product that may be loaded into the control unit 102.

From an examination of the characteristics of the disclosure obtained according to the present disclosure, the advantages that it affords are evident.

In particular, the presence of the calibration structures 72 in the sensor 50 and the calibration step 150′ of the control method 150 of the sensor 50 enable accurate measurement of the accelerations applied to the sensor 50, since this measurement is not affected by VRE due to the ZGO displacement that the sensor 50 might have.

Furthermore, increasing the number of the calibration structures 72 makes it possible to increase the intensity of the electrostatic actuation of the seismic mass 53, enabling extension of the range of calibration accelerations and thus the extent of characterization of the electrical properties of the sensor 50.

Furthermore, application of the reference acceleration accᵢₙ* to the sensor 50 may be carried out in a fast way by removably fixing to the movement apparatus the measurement device 100 (and thus the sensor 50 in its protective package). This entails times and costs that are significantly lower than those required for known characterizations of accelerometers.

Finally, it is clear that modifications and variations may be made to the disclosure described and illustrated herein, without thereby departing from the scope of the present disclosure, as defined in the annexed claims.

For instance, the different embodiments described may be combined with one another so as to provide further solutions.

Furthermore, the sensor 50 could be a generic inertial sensor of a MEMS type, such as a gyroscope.

Furthermore, it is possible to use the calibration structures 72 also in the measurement mode of the sensor 50 for applications other than calibration of the sensor 50. For instance, in the measurement mode of the sensor 50, the calibration structures 72 may also themselves be used for measuring the accelerations applied to the sensor 50, in a way similar to the measurement structure 68. In this case, the calibration structures 72 may be used to provide an estimate of the acceleration applied to the sensor 50, which may be compared with the measurement made by the measurement structure 68 in order to validate correctness of the latter.

A MEMS sensor (50) includes: a semiconductor body (51) having a surface (51a); and a mass (53) elastically coupled to the semiconductor body (51), facing said surface (51a) of the semiconductor body (51) and configured to oscillate relative to the semiconductor body (51) in a oscillation direction (61) in response to a force acting on the mass (53) in the oscillation direction (61), said force being caused by an acceleration applied to the MEMS sensor (50), wherein the mass (53) and the semiconductor body (51) define at least one measurement structure (68) with parallel-plate electrodes, configured to measure capacitively a position of the mass (53) with respect to the semiconductor body (51) in the oscillation direction (61), said position of the mass (53) being indicative of the acceleration applied to the MEMS sensor (50), and wherein the mass (53) and the semiconductor body (51) further define a first calibration structure (72) with comb-finger electrodes that is electrically controllable, in a calibration mode of the MEMS sensor (50), to electrostatically cause a displacement of the mass (53) with respect to the semiconductor body (51) in the oscillation direction (61).

The semiconductor body (51) includes a first plurality of fixed calibration electrodes (72b) that extend at the surface (51a) of the semiconductor body (51), each having, parallelly to the surface (51a) of the semiconductor body (51), a main extension parallel to the oscillation direction (61) and are spaced from one another orthogonally to the oscillation direction (61), wherein the mass (53) includes a first plurality of mobile calibration electrodes (72a) that each have, parallelly to the surface (51a) of the semiconductor body (51), a main extension parallel to the oscillation direction (61), are spaced from one another orthogonally to the oscillation direction (61), and are configured to oscillate with the mass (53) in the oscillation direction (61), wherein the mobile calibration electrodes (72a) and the fixed calibration electrodes (72b) of said first plurality are comb-fingered so as to form a first array (72A) of mobile calibration electrodes (72a) and fixed calibration electrodes (72b) that are alternated with one another orthogonally to the oscillation direction (61), wherein each pair made up of a mobile calibration electrode (72a) and a fixed calibration electrode (72b), consecutive to one another in the first array (72A) and capacitively coupled together, forms a respective variable-capacitance calibration capacitor (72′), wherein the mobile calibration electrodes (72a) and the fixed calibration electrodes (72b) of the first array (72A) form the first calibration structure (72), and wherein, in the calibration mode of the MEMS sensor (50), the mobile calibration electrodes (72a) and the fixed calibration electrodes (72b) of the first array (72A) are electrically controllable to vary the capacitances of the calibration capacitors (72′), the position of the mass (53) with respect to the semiconductor body (51) in the oscillation direction (61) being dependent upon the capacitances of the calibration capacitors (72′) of the first array (72A).

The semiconductor body (51) includes a second plurality of fixed calibration electrodes (72b) that extend on the surface (51a) of the semiconductor body (51), each having, parallelly to the surface (51a) of the semiconductor body (51), a main extension parallel to the oscillation direction (61) and are spaced from one another orthogonally to the oscillation direction (61), wherein the mass (53) includes a second plurality of mobile calibration electrodes (72a) that each have, parallelly to the surface (51a) of the semiconductor body (51), a main extension parallel to the oscillation direction (61), are spaced from one another orthogonally to the oscillation direction (61), and are configured to oscillate with the mass (53) in the oscillation direction (61), wherein the mobile calibration electrodes (72a) and the fixed calibration electrodes (72b) of said second plurality are comb-fingered so as to form a second array (72B) of mobile calibration electrodes (72a) and fixed calibration electrodes (72b) that are alternated with one another orthogonally to the oscillation direction (61), wherein the second array (72B) is arranged alongside the first array (72A) in the oscillation direction (61) so that the mobile calibration electrodes (72a) of the first array (72A) and of the second array (72B) are arranged in the oscillation direction (61) between the fixed calibration electrodes (72b) of the first array (72A) and of the second array (72B), wherein each pair of mobile calibration electrode (72a) and fixed calibration electrode (72b), consecutive to one another in the second array (72B) and capacitively coupled together, forms a respective variable-capacitance calibration capacitor (72′), wherein the mobile calibration electrodes (72a) and the fixed calibration electrodes (72b) of the second array (72B) form the first calibration structure (72) together with the mobile calibration electrodes (72a) and the fixed calibration electrodes (72b) of the first array (72A), and wherein, in the calibration mode of the MEMS sensor (50), the mobile calibration electrodes (72a) and the fixed calibration electrodes (72b) of the second array (72B) are electrically controllable to vary the capacitance of the respective calibration capacitors (72′), the position of the mass (53) with respect to the semiconductor body (51) in the oscillation direction (61) being dependent upon the capacitances of the calibration capacitors (72′) of the first array (72A) and of the second array (72B).

The mass (53) and the semiconductor body (51) further define at least one second calibration structure (72) with comb-finger electrodes, which, in the calibration mode of the MEMS sensor (50), are electrically controllable to cause, electrostatically and together with the first calibration structure (72), the displacement of the mass (53) with respect to the semiconductor body (51) in the oscillation direction (61).

The semiconductor body (51) include at least two fixed measurement electrodes (68b) spaced from one another in the oscillation direction (61), wherein the mass (53) includes at least one mobile measurement electrode (68a) arranged between the fixed measurement electrodes (68b) in the oscillation direction (61) and configured to oscillate with the mass (53) in the oscillation direction (61), wherein the mobile measurement electrode (68a) and the fixed measurement electrodes (68b) form the measurement structure (68), and wherein the mobile measurement electrode (68a) is capacitively coupled to the fixed measurement electrodes (68b) so as to form with the fixed measurement electrodes (68b) respective variable-capacitance measurement capacitors (68′, 68″), the capacitances of the measurement capacitors (68′, 68″) being dependent upon the position of the mass (53) with respect to the semiconductor body (51) in the oscillation direction (61).

The MEMS sensor (50) further includes an elastic assembly (57) mechanically coupled to the mass (53) and to the semiconductor body (51) and elastically deformable in the oscillation direction (61) to enable oscillation of the mass (53) with respect to the semiconductor body (51).

A measurement device (100) includes: a MEMS sensor (50); and a control unit (102) operatively coupled to the MEMS sensor (50); the control unit (102) being configured, during a calibration step (150′) of the MEMS sensor (50) where the MEMS sensor (50) is in the calibration mode, for: electrically controlling (S01) the first calibration structure (72) of the MEMS sensor (50) so as to displace the mass (53) with respect to the semiconductor body (51) in the oscillation direction (61), through the application to the first calibration structure (72) of a calibration input voltage (Vᵢₙ) that is progressively variable in an input-voltage range; while the calibration input voltage (Vᵢₙ) is applied to the first calibration structure (72), acquiring (S01), through the measurement structure (68) of the MEMS sensor (50), a measurement signal (Sₘ) as the calibration input voltage (Vᵢₙ) varies in the input-voltage range, the measurement signal (Sₘ) corresponding to a differential variation of capacitance (DCₒᵤₜ) of the measurement structure (68), and the behavior of the differential variation of capacitance (DCₒᵤₜ) as a function of the calibration input voltage (Vᵢₙ) defining a first curve (DCₒᵤₜ (Vᵢₙ)); while a reference acceleration (accᵢₙ*) is applied to the MEMS sensor (50) in the absence of the calibration input voltage (Vᵢₙ), acquiring (S03), through the measurement structure (68) of the MEMS sensor (50), a respective value of the measurement signal (Sₘ) corresponding to a reference differential variation of capacitance (DCₒᵤₜ*) at the reference acceleration (accᵢₙ*); determining (S05), on the basis of the first curve (DCₒᵤₜ(Vᵢₙ)), a reference calibration input voltage (Vᵢₙ*) of the calibration input voltage (Vᵢₙ), which in the first curve (DCₒᵤₜ(Vᵢₙ)) corresponds to the reference differential variation of capacitance (DCₒᵤₜ*) acquired at the reference acceleration (accᵢₙ*); and generating (S07), on the basis of the first curve (DCₒᵤₜ(Vᵢₙ)) and of the correspondence between the reference calibration input voltage (Vᵢₙ*) and the reference acceleration (accᵢₙ*), a second curve (DCₒᵤₜ (accᵢₙ)) corresponding to the plot of the differential variation of capacitance (DCₒᵤₜ) as a function of the acceleration (accᵢₙ) applied to the MEMS sensor (50).

The control unit (102) is further configured, during a measurement step (150″) of the MEMS sensor (50) wherein the MEMS sensor (50) is in a measurement mode alternative to the calibration mode and wherein the acceleration (Aₘ) to be measured is applied to the MEMS sensor (50), for: acquiring (S09), through the measurement structure (68) of the MEMS sensor (50), a respective value of the measurement signal (Sₘ) corresponding to a respective value of the differential variation of capacitance (DCₒᵤₜ) that is a function of the acceleration (Aₘ) to be measured; and determining (S11) the acceleration (Aₘ) applied to the MEMS sensor (50) on the basis of the acquired value of the measurement signal (Sₘ) and of the second curve (DCₒᵤₜ(accᵢₙ)).

The semiconductor body (51) includes at least two fixed measurement electrodes (68b) spaced from one another in the oscillation direction (61), wherein the mass (53) includes at least one mobile measurement electrode (68a) arranged between the fixed measurement electrodes (68b) in the oscillation direction (61) and configured to oscillate with the mass (53) in the oscillation direction (61), wherein the mobile measurement electrode (68a) and the fixed measurement electrodes (68b) form the measurement structure (68), wherein the mobile measurement electrode (68a) is capacitively coupled to the fixed measurement electrodes (68b) so as to form with the fixed measurement electrodes (68b) respective variable-capacitance measurement capacitors (68′, 68″), the capacitances of the measurement capacitors (68′, 68″) being dependent upon the position of the mass (53) with respect to the semiconductor body (51) in the oscillation direction (61), and wherein the differential variation of capacitance (DCₒᵤₜ) depends upon a difference between the capacitances of the measurement capacitors (68′, 68″).

The measurement device (100) further includes an interface unit (104) electrically coupled to the MEMS sensor (50) and to the control unit (102) and configured to: receive from the measurement structure (68) of the MEMS sensor (50) a first detection signal (Sᵣ₁) and a second detection signal (Sᵣ₂) indicative of the capacitances of the measurement capacitors (68′, 68″); and on the basis of the first detection signal (Sᵣ₁) and the second detection signal (Sᵣ₂), generate the measurement signal (Sₘ) dependent upon the difference between the capacitances of the measurement capacitors (68′, 68″).

A control method (150) executed by a measurement device (100), the control method (150) includes, during the calibration step (150′) of the MEMS sensor (50) wherein the MEMS sensor (50) is in the calibration mode: controlling (S01) the first calibration structure (72) of the MEMS sensor (50) so as to displace the mass (53) with respect to the semiconductor body (51) in the oscillation direction (61), through the application to the first calibration structure (72) of the calibration input voltage (Vᵢₙ) that is progressively variable in the input-voltage range; while the calibration input voltage (Vᵢₙ) is applied to the first calibration structure (72), acquiring (S01), through the measurement structure (68) of the MEMS sensor (50), the measurement signal (Sₘ) as the calibration input voltage (Vᵢₙ) varies in the input-voltage range, the measurement signal (Sₘ) corresponding to the differential variation of capacitance (DCₒᵤₜ) of the measurement structure (68), and the behavior of the differential variation of capacitance (DCₒᵤₜ) as a function of the calibration input voltage (Vᵢₙ) defining the first curve (DCₒᵤₜ(Vᵢₙ)); while the reference acceleration (accᵢₙ*) is applied to the MEMS sensor (50) in the absence of the calibration input voltage (Vᵢₙ), acquiring (S03), through the measurement structure (68) of the MEMS sensor (50), the respective value of the measurement signal (Sₘ) corresponding to the reference differential variation of capacitance (DCₒᵤₜ*) at the reference acceleration (accᵢₙ*); determining (S05), on the basis of the first curve (DCₒᵤₜ(Vᵢₙ)), the reference calibration input voltage (Vᵢₙ*) of the calibration input voltage (Vᵢₙ), which in the first curve (DCₒᵤₜ(Vᵢₙ)) corresponds to the reference differential variation of capacitance (DCₒᵤₜ*) acquired at the reference acceleration (accᵢₙ*); and generating (S07), on the basis of the first curve (DCₒᵤₜ(Vᵢₙ)) and the correspondence between the reference calibration input voltage (Vᵢₙ*) and the reference acceleration (accᵢₙ*), the second curve (DCₒᵤₜ(accᵢₙ)) corresponding to the behavior of the differential variation of capacitance (DCₒᵤₜ) as a function of the acceleration (accᵢₙ) applied to the MEMS sensor (50).

The control method (150) further includes, during a measurement step (150″) of the MEMS sensor (50) wherein the MEMS sensor (50) is in a measurement mode alternative to the calibration mode and wherein the acceleration (Aₘ) to be measured is applied to the MEMS sensor (50): acquiring (S09), through the measurement structure (68) of the MEMS sensor (50), a respective value of the measurement signal (Sₘ) corresponding to a respective value of the differential variation of capacitance (DCₒᵤₜ) that is a function of the acceleration (Aₘ) to be measured; and determining (S11) the acceleration (Aₘ) applied to the MEMS sensor (50) on the basis of the acquired value of the measurement signal (Sₘ) and of the second curve (DCₒᵤₜ(accᵢₙ)).

Determining (S11) the acceleration (Aₘ) applied to the MEMS sensor (50) on the basis of the acquired value of the measurement signal (Sₘ) and of the second curve (DCₒᵤₜ (accᵢₙ)) includes determining in the second curve (DCₒᵤₜ(accᵢₙ)) the value of the acceleration (accᵢₙ) that corresponds to the acquired value of the differential variation of capacitance (DCₒᵤₜ), said value of the acceleration (accᵢₙ) corresponding to the acquired value of the differential variation of capacitance (DCₒᵤₜ) being the measured value of the acceleration (Aₘ) applied to the MEMS sensor (50).

A computer program product storable in a control unit (102) of a measurement device (100), said computer program product includes being designed so that, when executed, the control unit (102) becomes configured to implement a control method (150).

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A MEMS sensor, comprising:
a semiconductor body having a surface; and
a mass elastically coupled to the semiconductor body, facing the surface of the semiconductor body and configured to oscillate relative to the semiconductor body in an oscillation direction in response to a force acting on the mass in the oscillation direction, the force being caused by an acceleration applied to the MEMS sensor,
wherein the mass and the semiconductor body define at least one measurement structure with parallel-plate electrodes, configured to measure capacitively a position of the mass with respect to the semiconductor body in the oscillation direction, the position of the mass being indicative of the acceleration applied to the MEMS sensor, and
wherein the mass and the semiconductor body further define a first calibration structure with comb-finger electrodes that is electrically controllable, in a calibration mode of the MEMS sensor, to electrostatically cause a displacement of the mass with respect to the semiconductor body in the oscillation direction.

2. The MEMS sensor according to claim 1, wherein the semiconductor body includes a first plurality of fixed calibration electrodes that extend at the surface of the semiconductor body, each have, parallelly to the surface of the semiconductor body, a main extension parallel to the oscillation direction and are spaced from one another orthogonally to the oscillation direction,
wherein the mass includes a first plurality of mobile calibration electrodes that each have, parallelly to the surface of the semiconductor body, a main extension parallel to the oscillation direction, are spaced from one another orthogonally to the oscillation direction, and are configured to oscillate with the mass in the oscillation direction,
wherein the mobile calibration electrodes and the fixed calibration electrodes of the first plurality are comb-fingered so as to form a first array of mobile calibration electrodes and fixed calibration electrodes that are alternated with one another orthogonally to the oscillation direction,
wherein each pair made up of a mobile calibration electrode and a fixed calibration electrode, consecutive to one another in the first array and capacitively coupled together, forms a respective variable-capacitance calibration capacitor,
wherein the mobile calibration electrodes and the fixed calibration electrodes of the first array form the first calibration structure, and
wherein, in the calibration mode of the MEMS sensor, the mobile calibration electrodes and the fixed calibration electrodes of the first array are electrically controllable to vary the capacitances of the calibration capacitors, the position of the mass with respect to the semiconductor body in the oscillation direction being dependent upon the capacitances of the calibration capacitors of the first array.

3. The MEMS sensor according to claim 2, wherein the semiconductor body comprises a second plurality of fixed calibration electrodes that extend on the surface of the semiconductor body, each have, parallelly to the surface of the semiconductor body, a main extension parallel to the oscillation direction and are spaced from one another orthogonally to the oscillation direction,
wherein the mass comprises a second plurality of mobile calibration electrodes that each have, parallelly to the surface of the semiconductor body, a main extension parallel to the oscillation direction, are spaced from one another orthogonally to the oscillation direction, and are configured to oscillate with the mass in the oscillation direction,
wherein the mobile calibration electrodes and the fixed calibration electrodes of the second plurality are comb-fingered so as to form a second array of mobile calibration electrodes and fixed calibration electrodes that are alternated with one another orthogonally to the oscillation direction,
wherein the second array is arranged alongside the first array in the oscillation direction so that the mobile calibration electrodes of the first array and of the second array are arranged in the oscillation direction between the fixed calibration electrodes of the first array and of the second array,
wherein each pair of mobile calibration electrode and fixed calibration electrode, consecutive to one another in the second array and capacitively coupled together, forms a respective variable-capacitance calibration capacitor,
wherein the mobile calibration electrodes and the fixed calibration electrodes of the second array form the first calibration structure together with the mobile calibration electrodes and the fixed calibration electrodes of the first array, and
wherein, in the calibration mode of the MEMS sensor, the mobile calibration electrodes and the fixed calibration electrodes of the second array are electrically controllable to vary the capacitance of the respective calibration capacitors, the position of the mass with respect to the semiconductor body in the oscillation direction being dependent upon the capacitances of the calibration capacitors of the first array and of the second array.

4. The MEMS sensor according to claim 1, wherein the mass and the semiconductor body further define at least one second calibration structure with comb-finger electrodes, which, in the calibration mode of the MEMS sensor, are electrically controllable to cause, electrostatically and together with the first calibration structure, the displacement of the mass with respect to the semiconductor body in the oscillation direction.

5. The MEMS sensor according to claim 1, wherein the semiconductor body comprises at least two fixed measurement electrodes spaced from one another in the oscillation direction,
wherein the mass comprises at least one mobile measurement electrode arranged between the fixed measurement electrodes in the oscillation direction and configured to oscillate with the mass in the oscillation direction,
wherein the mobile measurement electrode and the fixed measurement electrodes form the measurement structure, and
wherein the mobile measurement electrode is capacitively coupled to the fixed measurement electrodes so as to form with the fixed measurement electrodes respective variable-capacitance measurement capacitors, the capacitances of the measurement capacitors being dependent upon the position of the mass with respect to the semiconductor body in the oscillation direction.

6. The MEMS sensor according to claim 1, further comprising an elastic assembly mechanically coupled to the mass and to the semiconductor body and elastically deformable in the oscillation direction to enable oscillation of the mass with respect to the semiconductor body.

7. The MEMS sensor of claim 1, wherein the mass and the semiconductor body further define at least one second calibration structure with comb-finger electrodes, which, in the calibration mode of the MEMS sensor, are electrically controllable to cause, electrostatically and together with the first calibration structure, the displacement of the mass with respect to the semiconductor body in the oscillation direction, and the at least one first calibration structure and the at least one second calibration structure are opposite about the at least one measurement structures.

8. The MEMS sensor claim 7, wherein the semiconductor body includes:
a first plurality of fixed calibration electrodes that extend at the surface of the semiconductor body;
a second plurality of fixed calibration electrodes that extend at the surface of the semiconductor body and are spaced apart from the first plurality of fixed calibration electrodes; and
at least two fixed measurement electrodes that extend at the surface of the semiconductor body and are between the first plurality of fixed calibration electrodes and the second plurality of fixed calibration electrodes.

9. The MEMS sensor claim 8, wherein the mass includes:
a first plurality of mobile calibration electrodes that are in close proximity to the first plurality of fixed calibration electrodes;
a second plurality of mobile calibration electrodes that are in close proximity to the second plurality of fixed calibration electrodes; and
at least one mobile measurement electrode that is between the at least two fixed measurement electrodes.

10. The MEMS sensor claim 9, wherein the mass further includes:
a first opening in which the first plurality of fixed calibration electrodes are present;
a second opening in which the second plurality of calibration electrodes are present; and
a third opening in which the at least two fixed measurement electrodes are present, and the third opening is between the first opening and the second opening.

11. The MEMS sensor claim 10, wherein:
the first plurality of mobile calibration electrodes delimit the first opening;
the second plurality of mobile calibration electrodes delimit the second opening; and
the at least one mobile measurement electrode delimits the third opening.

12. The MEMS sensor of claim 1, wherein the mass is elastically coupled to a plurality of fixing elements that extend at the surface of the semiconductor body by a plurality of springs.

13. A measurement device, comprising:
a MEMS sensor including:
a semiconductor body having a surface; and
a mass elastically coupled to the semiconductor body, facing the surface of the semiconductor body and configured to oscillate relative to the semiconductor body in an oscillation direction in response to a force acting on the mass in the oscillation direction, the force being caused by an acceleration applied to the MEMS sensor,
wherein the mass and the semiconductor body define at least one measurement structure with parallel-plate electrodes, configured to measure capacitively a position of the mass with respect to the semiconductor body in the oscillation direction, the position of the mass being indicative of the acceleration applied to the MEMS sensor, and
wherein the mass and the semiconductor body further define a first calibration structure with comb-finger electrodes that is electrically controllable, in a calibration mode of the MEMS sensor, to electrostatically cause a displacement of the mass with respect to the semiconductor body in the oscillation direction;
a control unit operatively coupled to the MEMS sensor;
the control unit being configured, during a calibration step of the MEMS sensor where the MEMS sensor is in the calibration mode, for:
electrically controlling the first calibration structure of the MEMS sensor so as to displace the mass with respect to the semiconductor body in the oscillation direction, through the application to the first calibration structure of a calibration input voltage that is progressively variable in an input-voltage range;
while the calibration input voltage is applied to the first calibration structure, acquiring, through the measurement structure of the MEMS sensor, a measurement signal as the calibration input voltage varies in the input-voltage range, the measurement signal corresponding to a differential variation of capacitance of the measurement structure, and the behavior of the differential variation of capacitance as a function of the calibration input voltage defining a first curve;
while a reference acceleration is applied to the MEMS sensor in the absence of the calibration input voltage, acquiring, through the measurement structure of the MEMS sensor, a respective value of the measurement signal corresponding to a reference differential variation of capacitance at the reference acceleration;
determining, on the basis of the first curve, a reference calibration input voltage of the calibration input voltage, which in the first curve corresponds to the reference differential variation of capacitance acquired at the reference acceleration; and
generating, on the basis of the first curve and of the correspondence between the reference calibration input voltage and the reference acceleration, a second curve corresponding to the plot of the differential variation of capacitance as a function of the acceleration applied to the MEMS sensor.

14. The measurement device according to claim 13, wherein the control unit is further configured, during a measurement step of the MEMS sensor wherein the MEMS sensor is in a measurement mode alternative to the calibration mode and wherein the acceleration to be measured is applied to the MEMS sensor, for:
acquiring, through the measurement structure of the MEMS sensor, a respective value of the measurement signal corresponding to a respective value of the differential variation of capacitance that is a function of the acceleration to be measured; and
determining the acceleration applied to the MEMS sensor on the basis of the acquired value of the measurement signal and of the second curve.

15. The measurement device according to claim 13, wherein the semiconductor body comprises at least two fixed measurement electrodes spaced from one another in the oscillation direction,
wherein the mass comprises at least one mobile measurement electrode arranged between the fixed measurement electrodes in the oscillation direction and configured to oscillate with the mass in the oscillation direction,
wherein the mobile measurement electrode and the fixed measurement electrodes form the measurement structure,
wherein the mobile measurement electrode is capacitively coupled to the fixed measurement electrodes so as to form with the fixed measurement electrodes respective variable-capacitance measurement capacitors, the capacitances of the measurement capacitors being dependent upon the position of the mass with respect to the semiconductor body in the oscillation direction, and
wherein the differential variation of capacitance depends upon a difference between the capacitances of the measurement capacitors.

16. The measurement device according to claim 15, further comprising an interface unit electrically coupled to the MEMS sensor and to the control unit and configured to:
receive from the measurement structure of the MEMS sensor a first detection signal and a second detection signal indicative of the capacitances of the measurement capacitors; and
on the basis of the first detection signal and the second detection signal, generate the measurement signal dependent upon the difference between the capacitances of the measurement capacitors.

17. The measurement device of claim 15, wherein:
the mass further includes:
a first opening; and
a second opening spaced apart from the first opening;
the at least one measurement structure is within the first opening; and
the first calibration structure is within the first opening.

18. A method, comprising:
a MEMS sensor including:
a semiconductor body having a surface; and
a mass elastically coupled to the semiconductor body, facing the surface of the semiconductor body and configured to oscillate relative to the semiconductor body in a oscillation direction in response to a force acting on the mass in the oscillation direction, the force being caused by an acceleration applied to the MEMS sensor,
wherein the mass and the semiconductor body define at least one measurement structure with parallel-plate electrodes, configured to measure capacitively a position of the mass with respect to the semiconductor body in the oscillation direction, the position of the mass being indicative of the acceleration applied to the MEMS sensor, and
wherein the mass and the semiconductor body further define a first calibration structure with comb-finger electrodes that is electrically controllable, in a calibration mode of the MEMS sensor, to electrostatically cause a displacement of the mass with respect to the semiconductor body in the oscillation direction;
during the calibration step of the MEMS sensor, wherein the MEMS sensor is in the calibration mode:
controlling the first calibration structure of the MEMS sensor so as to displace the mass with respect to the semiconductor body in the oscillation direction, through the application to the first calibration structure of the calibration input voltage that is progressively variable in the input-voltage range;
while the calibration input voltage is applied to the first calibration structure, acquiring, through the measurement structure of the MEMS sensor, the measurement signal as the calibration input voltage varies in the input-voltage range, the measurement signal corresponding to the differential variation of capacitance of the measurement structure, and the behavior of the differential variation of capacitance as a function of the calibration input voltage defining the first curve;
while the reference acceleration is applied to the MEMS sensor in the absence of the calibration input voltage, acquiring, through the measurement structure of the MEMS sensor, the respective value of the measurement signal corresponding to the reference differential variation of capacitance at the reference acceleration;
determining, on the basis of the first curve, the reference calibration input voltage of the calibration input voltage, which in the first curve corresponds to the reference differential variation of capacitance acquired at the reference acceleration; and
generating, on the basis of the first curve and the correspondence between the reference calibration input voltage and the reference acceleration, the second curve corresponding to the behavior of the differential variation of capacitance as a function of the acceleration applied to the MEMS sensor.

19. The method according to claim 18, further comprising, during a measurement step of the MEMS sensor wherein the MEMS sensor is in a measurement mode alternative to the calibration mode and wherein the acceleration to be measured is applied to the MEMS sensor:
acquiring, through the measurement structure of the MEMS sensor, a respective value of the measurement signal corresponding to a respective value of the differential variation of capacitance that is a function of the acceleration to be measured; and
determining the acceleration applied to the MEMS sensor on the basis of the acquired value of the measurement signal and of the second curve.

20. The method according to claim 19, wherein determining the acceleration applied to the MEMS sensor on the basis of the acquired value of the measurement signal and of the second curve comprises determining in the second curve the value of the acceleration that corresponds to the acquired value of the differential variation of capacitance, the value of the acceleration corresponding to the acquired value of the differential variation of capacitance being the measured value of the acceleration applied to the MEMS sensor.
